(19) United States
(12) Patent Application Publication
(10) Pub. No.: US 2009/0233032 A1
(43) Pub. Date: Sep. 17, 2009

(54) J&J safety lens protectors

(76) Inventor: James Craig, Mt. Ranch, CA (US)

Correspondence Address: Lee Denis, Apt D, 638 E Tujunga Ave, Burbank, CA, 91501, US

(21) Appl. No.: 12/075,347

(22) Filed: Mar. 11, 2008

(51) Int. Cl. B32B 33/00

(52) U.S. Cl. 428/41.7

(57) ABSTRACT

One embodiment of the lens protectors attached to pre-manufactured safety lenses, or goggles. The lens protectors are made up of clear self adhesive plastic strips, with easy to use peeling tabs. Each set of lens protectors contains several peel-off protective strips.

### CROSS REFERENCE TO RELATED APPLICATIONS

This application does not have a provisional patent application associated with it.

### FEDERALLY SPONSORED RESEARCH

Not Applicable

### SEQUENCE LISTING OR PROGRAM

Not Applicable

### BACKGROUND

1. Field of Invention

This invention relates to safety lens protectors, specifically to reusable protectors for construction safety glasses and goggles.

2. Prior Art

Safety glasses and Safety goggles are commonly used by construction workers, auto repair workers, truck drivers delivering hazardous products, oil field workers, refuse disposal management companies, agricultural maintenance employees, city and state maintenance employees, sewage, and water treatment plants, government agencies, landscaping maintenance and all industries that require employees to protect there eyes. In addition, safety goggles and glasses are used for home improvements, and personal activities. These glasses can be easily damaged or scratched in a construction or home workshop environment. Once these glasses are damaged they impair the vision of the user, and must be immediately replaced with a new pair of glasses. This can be costly for companies, not only due to the cost of the new glasses, but also due to lost time and productivity while getting new glasses. When vision is impaired due to ware and tear directly to the lens the employees do not always take the time to go and get a new pair of glasses. Potential eye hazards are found in nearly every industry. Occupational safety and health administration (OSHA) standards require that employers provide workers with suitable eye protection. To be effective in preventing injury, the eyewear must be of the appropriate type for the hazard encountered, and it must be properly fitted. Scratch resistant gradient coatings have been designed to alleviate this problem. U.S. Pat. No. 7,264,669 to Tribofilm research inc. discloses the details on the coating. Although this helps to increase the life of the safety glasses, this could be costly. In addition, once the glasses are damaged, they will need immediate replacement. Safety glasses with replaceable lenses have been designed. U.S. Pat. No. 7,011,404 to Bacou-Dalloz Eye and Face Protection, Inc. discloses the details of an interchangeable single lens system suitable for use on safety glasses. This option can still be somewhat costly, as it requires the replacement of an entire lens. In addition, there is still added cost in the lost production time, in order to replace the lens in the safety glasses or goggles.

### SUMMARY

The J & J Safety Lens Protectors is designed to put 6-10 clear safety lens protector replacements that will contour and adhere to manufactured safety class lenses. As the safety glasses become scratched, splattered, or otherwise damaged to impair user vision, the tabs can be peeled off to reveal a new unimpaired surface. The process can be repeated with a new pack of 6-10 safety lens protectors. The ease of use is more time efficient than other previous products, and less costly as the lens protectors are less expensive than replacing entire glasses or lenses.

### DRAWINGS

### Figures

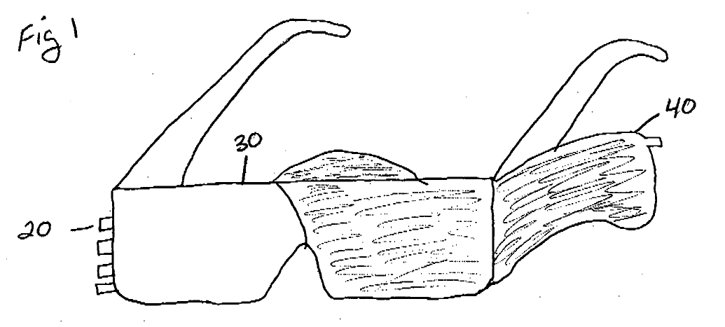

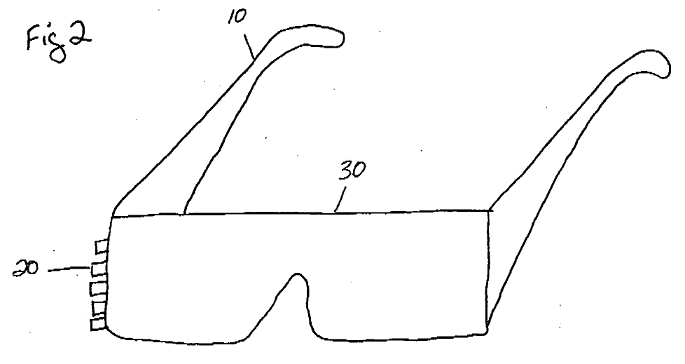

FIG. 1 shows peel off tabs designed to quickly and easily discard lens protectors as they become scratched or otherwise impaired.

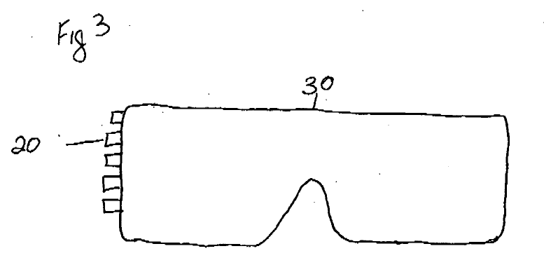

FIG. 2 shows the lens protectors designed to contour and adhere to manufactured glasses.

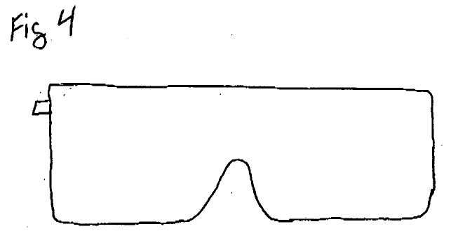

FIG. 3 shows the replacement kit.

### DETAILED DESCRIPTION

### FIG. 1

One embodiment of the lens protectors is illustrated in FIG. 1 (front view). The lens protectors 30 are shown attached to pre-manufactured safety goggles 10. The easy to use peeling tabs are shown in this view 20. A discarded protector 40 is shown as it is peeled off to reveal the next protector.

### FIG. 2

One embodiment of the lens protectors is illustrated in FIG. 2 (front view). The lens protectors 30 are shown attached to pre-manufactured safety goggles 10. The easy to use peeling tabs are shown in this view 20.

### FIG. 3

FIG. 3 illustrates a replacement kit 30. This kit is comprised of seven easy to peel disposable protectors 20.

I claim:

1. In a set of replaceable lens protectors comprising multiple layers of clear self-adhesive strips that are applied to pre-manufactured safety lenses.

2. The self adhesive strips of claim 1 is composed of a clear self-adhesive plastic material.

3. The lens protectors of claim 1 adhere to pre-manufactured glasses.

4. The lens protectors of claim 1 are shaped to fit several different types of pre-manufactured safety glasses or goggles.
